(19) United States
(12) Patent Application Publication
(10) Pub. No.: US 2020/0320463 A1
(43) Pub. Date: Oct. 8, 2020

(54) APPARATUS, METHODS AND SYSTEMS FOR RECEIVING AND PROVIDING INFORMATION FOR TRANSPORTING PACKAGES SENT BETWEEN A SENDING USER AND A RECEIVING USER VIA A TRANSPORTING USER

(71) Applicant: Will J. Amarante, Miami, FL (US)

(72) Inventor: Will J. Amarante, Miami, FL (US)

(21) Appl. No.: 16/829,908

(22) Filed: Mar. 25, 2020

Related U.S. Application Data
(60) Provisional application No. 62/823,273, filed on Mar. 25, 2019.

(51) Int. Cl. G06Q 10/08; H04L 9/32

(52) U.S. Cl. CPC G06Q 10/083; H04L 9/32

(57) ABSTRACT

A system for receiving and providing information for transporting packages. The system includes processors for sending user interfaces (“UI”) for receiving data associated with the users. The process is configured for providing to the sending user remote computing device, a UI for accepting package data to be sent to a receiving user. The processor after receiving the package data, provides to the remote computing device of the receiving user, a UI for receiving receiver acceptance information. The receiver acceptance information indicates that the user accepts the package. Then, the processor includes the receiving user information in the package data and sending to transporting user's computing devices aligning with transporting criteria within the package data. The processor, provides to the device of each transporting user aligning with transporting criteria within the package data, a UI configured for displaying package data having the receiving user information and for receiving transporting acceptance data.

### CROSS-REFERENCE TO RELATED APPLICATIONS

The present U.S. Utility patent application claims priority pursuant to 35 U.S.C. § 119(e) to U.S. Provisional Application No. 62/823,273 entitled “APPARATUS, METHODS AND SYSTEMS FOR RECEIVING AND PROVIDING INFORMATION FOR TRANSPORTING PACKAGES SENT BETWEEN A SENDING USER AND A RECEIVING USER VIA A TRANSPORTING USER”, filed Mar. 25, 2019, which is hereby incorporated herein by reference in its entirety and made part of the present U.S. Utility patent application for all purposes.

### STATEMENT REGARDING FEDERALLY SPONSORED RESEARCH OR DEVELOPMENT

Not applicable.

### INCORPORATION BY REFERENCE OF MATERIAL SUBMITTED ON A COMPACT DISC

Not applicable.

### TECHNICAL FIELD

The present invention relates to the field of transporting packages, and more specifically computer applications used for transporting packages.

### BACKGROUND

People have been transporting packages from one place to another for centuries. Delivery by mailing courier services date back to the Persian Empire. In the United States, the USPS was formed in 1775 by the second Continental Congress. Later, in the 19^{th} century, in the United States, groups like Wells Fargo formed the Pony Express, a rapid mailing package delivery service that reduced travel time from the Pacific to the Atlantic Coast.

Now, the Courier, Express and Parcel (CEP) market includes companies that provide logistics and postal services varying in the type of services offered, such as delivery speed or weight and volume of a shipment. In 2015, the estimated North American CEP market revenue amounted to around 60 billion Euros and is expected to increase at a compound annual growth rate of five percent between the period of 2015 to 2025. To say that the courier, express, and package delivery markets is large is an understatement. Many large carriers are able to transport numerous packages at once. Large carriers, and even small carriers have very specific deadlines to meet. However, many times the planes, trucks and automobiles of these large carriers must travel to meet deadlines when these vehicles are not full or not at maximum capacity.

Recently, advances in technology have resulted in services, such as on-demand transportation services, becoming popular due to the ability to conveniently book transportation in real-time in order to send packages across town. Not only have these services allowed individuals to commute more conveniently, but these services also possess the capability of reducing inefficiencies associated with the current parcel shipping industry. For example, it is common for courier vehicles and on-demand transportation vehicles to not be at max capacity when traveling from one location to another resulting in a waste of space and increase in pollution that could otherwise be eliminated if there was a more efficient way to occupy free space for transporting packages.

Also, parcel transporting services are commonly considered undependable due to circumstances caused by overloading. For example, time-periods such as the holidays when utilization of parcel transportation services are at the highest demand typically result in packages being lost or received later than expected due to the influx of orders and the inability to satisfy each and every stipulation associated with the packages on a courier vehicle.

As a result, there exists a need for improvements over the prior art and more particularly for a more efficient way of transporting packages to eliminate the inefficiencies commonly associated with the parcel transporting industry.

### SUMMARY

An apparatus, systems, and methods for receiving and providing information for transporting packages sent between a sending user and a receiving user via a transporting user is disclosed. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, a system for receiving and providing information for transporting packages sent between a sending user and a receiving user via a transporting user is disclosed. The system is provided over a communications network and comprises: one or more processors; one or more storage media storing instructions which, when executed by the one or more processors cause: sending, to a remote computing device of each a sending user, a receiving user, and a transporting user, a graphical user interface for receiving data associated with the sending user, receiving user, and transporting user, respectively; after receiving a request to send a package, providing to the sending user remote computing device, a sending package GUI for accepting package data to be sent to a receiving user, wherein the package data includes package related information; after receiving the package data, providing to the remote computing device of the receiving user, a receiving package GUI for receiving receiver acceptance information; wherein if the receiver acceptance information indicates that the receiving user accepts the package associated with the package data, then including the receiving user information in the package data and sending the package data to a plurality of remote computing devices of transporting users having itinerary data that aligns with transporting criteria within the package data; and providing to the remote computing device of each of the plurality of transporting users having itinerary data that aligns with transporting criteria within the package data, a transporting package GUI configured for displaying package data having the receiving user information and for receiving transporting acceptance data.

In one embodiment, a system for receiving and providing information for transporting packages sent between a sending user and a receiving user via a transporting user is disclosed. The system is provided over a communications network and comprises: one or more processors; one or more storage media storing instructions which, when executed by the one or more processors cause: sending, to a remote computing device of each a sending user, a receiving user and a transporting user, a graphical user interface for receiving data associated with the sending user, receiving user and transporting user, respectively; creating a sending record for the sending user, a receiving record for the receiving user and a transporting record for the transporting user, respectively; storing, in the database, user data received from the sending user, receiving user and transporting user in the record corresponding to the sending user, receiving user and transporting user respectively; after receiving a request to send a package, providing to the sending user remote computing device, a sending package GUI for accepting package data to be sent to a receiving user, wherein the package data includes package related information and the receiving user data that is proposed to accept the package at a destination location; after receiving the package data, providing to the remote computing device of the receiving user proposed by the sending user in the sending package GUI, a receiving package GUI for receiving receiver acceptance information, wherein the receiver acceptance information includes data elements for at least one of accepting and rejecting the package identified by the package data input into the package data GUI, wherein if the receiver acceptance information indicates that the receiving user does not accept the package, then not posting any of the package data to any transporting user, and, wherein if the receiver acceptance information indicates that the receiving user accepts the package associated with the package data, then including the receiving user information in the package data and sending the package data to a plurality of remote computing devices of transporting users having itinerary data that aligns with transporting criteria within the package data; and providing to the remote computing device of each of the plurality of transporting users having itinerary data that aligns with transporting criteria within the package data, a transporting package GUI configured for displaying package data having the receiving user information and for receiving transporting acceptance data, wherein the transporting acceptance data includes data elements if the transporting user agrees to transport the package associated with package data.

In one embodiment, a method for receiving and providing information for transporting packages sent between a sending user and a receiving user via a transporting user is disclosed. The method comprises: sending, to a remote computing device of each a sending user, a receiving user and a transporting user, a graphical user interface for receiving data associated with the sending user, receiving user and transporting user, respectively; creating a sending record for the sending user, a receiving record for the receiving user and a transporting record for the transporting user, respectively; storing, in the database, user data received from the sending user, receiving user and transporting user in the record corresponding to the sending user, receiving user and transporting user respectively; after receiving a request to send a package, providing to the sending user remote computing device, a sending package GUI for accepting package data to be sent to a receiving user, wherein the package data includes package related information and the receiving user data that is proposed to accept the package at a destination location; after receiving the package data, providing to the remote computing device of the receiving user proposed by the sending user in the sending package GUI, a receiving package GUI for receiving receiver acceptance information, wherein the receiver acceptance information includes data elements for at least one of accepting and rejecting the package identified by the package data input into the package data GUI, wherein if the receiver acceptance information indicates that the receiving user does not accept the package, then not posting any of the package data to any transporting user, and, wherein if the receiver acceptance information indicates that the receiving user accepts the package associated with the package data, then including the receiving user information in the package data and sending the package data to a plurality of remote computing devices of transporting users having itinerary data that aligns with transporting criteria within the package data; providing to the remote computing device of each of the plurality of transporting users having itinerary data that aligns with transporting criteria within the package data, a transporting package GUI configured for displaying package data having the receiving user information and for receiving transporting acceptance data, wherein the transporting acceptance data includes data elements if the transporting user agrees to transport the package associated with package data; and wherein the method is performed by one or more computing devices.

Additional aspects of the disclosed embodiment will be set forth in part in the description which follows, and in part will be obvious from the description, or may be learned by practice of the disclosed embodiments. The aspects of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute part of this specification, illustrate embodiments of the invention and together with the description, serve to explain the principles of the disclosed embodiments. The embodiments illustrated herein are presently preferred, it being understood, however, that the invention is not limited to the precise arrangements and instrumentalities shown, wherein:

FIG. 1 is a diagram of an operating environment that supports a computer application for receiving and providing information for transporting packages sent between a sending user and a receiving user via a transporting user, according to an example embodiment;

FIG. 2 is a flowchart showing the process or control flow of one of the processes for receiving and providing information for transporting packages sent between a sending user and a receiving user via a transporting user, according to an example embodiment;

FIG. 2A is a flowchart showing the process or control flow of one of the processes for providing inspection information for transporting packages sent between a sending user and a receiving user via a transporting user, according to an example embodiment;

FIG. 3A is a flowchart showing the data flow between the server and the sending user for receiving and providing information for transporting packages sent between a sending user and a receiving user via a transporting user, according to an example embodiment;

FIG. 3B is a flowchart showing the data flow between the server and the receiving user of the process for receiving and providing information for transporting packages sent between a sending user and a receiving user via a transporting user, according to an example embodiment;

FIG. 3C is a flowchart showing the data flow between the server and the transporting user for receiving and providing information for transporting packages sent between a sending user and a receiving user via a transporting user, according to an example embodiment;

FIG. 3D is a flowchart showing the data flow between the server and the inspecting user for receiving and providing information for inspecting packages sent between a sending user and a receiving user via a transporting user, according to an example embodiment;

FIG. 4A is a graphical user interface provided to the remote computing devices of the users for receiving user data input by the users, according to an example embodiment;

FIG. 4A1 is a graphical user interface provided to the remote computing devices of the users for selecting to either send, transport or transport a package, according to an example embodiment;

FIG. 4B1 is a graphical user interface provided to the remote computing device of the sending user for receiving package data related to packages to send between a sending user and a receiving user via a transporting user, according to an example embodiment;

FIG. 4B2 is a continuation of the graphical user interface provided to the remote computing device of the sending user for receiving package data related to packages to send between a sending user and a receiving user via a transporting user, according to an example embodiment;

FIG. 5A is a graphical user interface provided to the remote computing device of the sending user for confirming package date before transmitting the information to the server, according to an example embodiment;

FIG. 5B is a graphical user interface provided to the remote computing device of the transporting user displaying packages that match the itinerary criteria of the transporting criteria, according to an example embodiment;

FIG. 6A is a graphical user interface provided to the remote computing device of the receiving user for providing data accepting or declining a request to transport a package, according to an example embodiment;

FIG. 6B is a graphical user interface provided to the remote computing device of the transporting user for itinerary data, according to an example embodiment;

FIG. 7 is a graphical user interface provided to the remote computing device of the sending user displaying a notification after the transporter agrees to transport a package, according to an example embodiment;

FIG. 8 is a graphical user interface provided to the remote computing device of the transporting user displaying a request requesting input for the transporting user has inspected the package, according to an example embodiment;

FIG. 9 is a graphical user interface provided to the remote computing device of the transporting user displaying a notification after the transporter agrees to transport a package, according to an example embodiment;

FIG. 10 is a graphical user interface provided to the remote computing device of the receiving user displaying a request requesting input for the receiving user has inspected the package, according to an example embodiment; and,

FIG. 11 is a graphical user interface provided to the remote computing device of the receiving user displaying a notification after the receiving agrees to accept a package, according to an example embodiment.

FIG. 12 is a block diagram of a system including an example computing device and other computing devices;

Like reference numerals refer to like parts throughout the several views of the drawings.

### DETAILED DESCRIPTION

The following detailed description refers to the accompanying drawings. Whenever possible, the same reference numbers are used in the drawings and the following description to refer to the same or similar elements. While disclosed embodiments may be described, modifications, adaptations, and other implementations are possible. For example, substitutions, additions or modifications may be made to the elements illustrated in the drawings, and the methods described herein may be modified by substituting reordering, or adding additional stages or components to the disclosed methods and devices. Accordingly, the following detailed description does not limit the disclosed embodiments. Instead, the proper scope of the disclosed embodiments is defined by the appended claims.

The disclosed embodiments improve upon the problems with the prior art by providing an apparatus, systems and methods for receiving and providing information for transporting packages sent between a sending user and a receiving user via a transporting user. The present embodiment improves over prior art by providing a system for coordinating on-demand pick-up and delivery of parcels in real-time between a sender, receiver, and transporter. Moreover, various graphical user interfaces are provided to the sender, receiver, and transporter in order to receive various information, such as package data and itinerary data, and communicatively couple the sender, receiver, and transporter to ensure secure and effective delivery of a parcel by matching the itinerary of the transporting user to the data related to a package that needs to be transported and confirming that the receiving user agrees to accept the package. Additionally, the disclosed embodiments improve over the prior art by using verification and authorization mechanisms in order to prevent tampering or damaging to the parcel during each stage of the parcel transporting process.

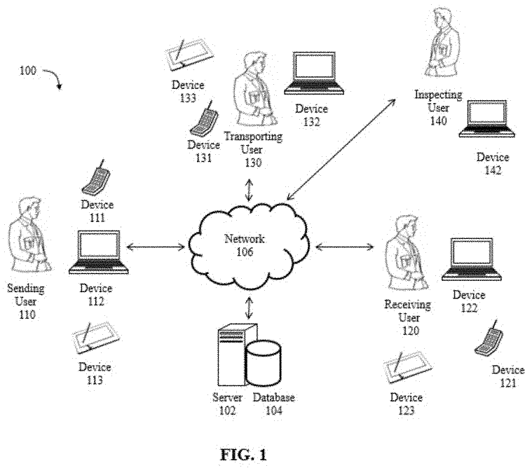

Referring now to the Figures, FIG. 1 is a diagram of an operating environment or system 100 that supports a computer application for receiving and providing information for transporting packages sent between a sending user 110 and a receiving user 120 via a transporting user 130 (collectively referred to as “the users”) over a communication network 106, according to an example embodiment. The environment 100 may comprise devices 111, 112, 113, 121, 122, 123, 131, 132, 133, 142 and servers 102, all of which may communicate with server 102 via a communications network 106. The operating environment illustrates several remote devices for each of the sending user 110, receiving user 120, transporting user 130 and inspecting user 140. This is intended to illustrate that a variety of different devices such as, mobile phone, tablet, smart phone, laptop, wearable technology, or desktop may be used as a remote device that is remote location from the server 102. However, it is understood that the number of remote computing devices may be greatly increased.

Remote devices 111, 112, 113, 121, 122, 123, 131, 132, 133, 142 may comprise any computing devices, such as integrated circuits, printed circuit boards, processors, ASICs, PCBs, cellular telephones, smart phones, tablet computers, laptops, and game consoles, for example. Remote devices 111, 112, 113, 121, 122, 123, 131, 132, 133, 142 may be connected either wirelessly to the communications network 106. Communications network 106 may include one or more packet switched networks, such as the Internet, or any local area networks, wide area networks, enterprise private networks, cellular networks, phone networks, mobile communications networks, or any combination of the above. In one embodiment, remote devices 111, 112, 113, 121, 122, 123, 131, 132, 133, 142 are a programmable logic controller or PLC.

Server 102 includes a software engine that delivers applications, data, program code and other information to networked devices 111, 112, 113, 121, 122, 123, 131, 132, 133, 142. The software engine of server 102 may perform other processes such as transferring multimedia data in a stream of packets that are interpreted and rendered by a software application as the packets arrive. FIG. 1 further shows that server 102 includes a database or repository 104, which may be a relational database comprising a Structured Query Language (SQL) database stored in a SQL server or a database that adheres to the NoSQL paradigm. Devices 111, 112, 113, 121, 122, 123, 131, 132, 133, 142 may also each include databases. The database 104 may serve sensor data, as well as related information, used by server 102 and devices 111, 112, 113, 121, 122, 123, 131, 132, 133, 142 during the course of operation of the invention. For example, such devices may include a first sensor for providing the position locating element, such as GPS technology, and a wireless communication element, such as WIFI, Bluetooth, NFC etc., that is configured to determine if remote computing device is within the proximity of other mobile devices.

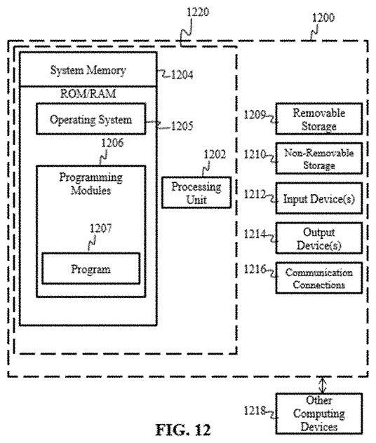

Devices 111, 112, 113, 121, 122, 123, 131, 132, 133, 142 and server 102 may each include program logic comprising computer source code, scripting language code or interpreted language code that perform various functions of the present invention. In one embodiment, the aforementioned program logic may comprise program module 1207 in FIG. 12. It should be noted that although FIG. 1 shows only one device 111, 112, 113, 121, 122, 123, 131, 132, 133, 142 and one server 102, the system of the present invention supports any number of computing devices, servers and remote computing devices connected via network 106. Also note that although server 102 is shown as a single and independent entity, in one embodiment, server 102 and its functionality can be realized in a centralized fashion in one computer system or in a distributed fashion wherein different elements are spread across several interconnected computer systems.

Various types of data may be stored in the database 104 of server 102. For example, the database may be the configured to store user data of each user in a user record. The user data includes at least a user first name, user last name, user address, at least one piece of identification, a user email address, banking information (account/routing numbers), credit/debit card information, and any applicable user information associated with online payment systems, such as Paypal, Venmo, CashApp, etc (referred to collectively as payment information), inspection related data. In one embodiment, the user data may include a user name, age, email address, package data, usual itinerary data, etc. Additionally, user data may include GPS position data, social media data, emergency contact information, as well as many other parameters that are within the spirit and scope of the present invention.

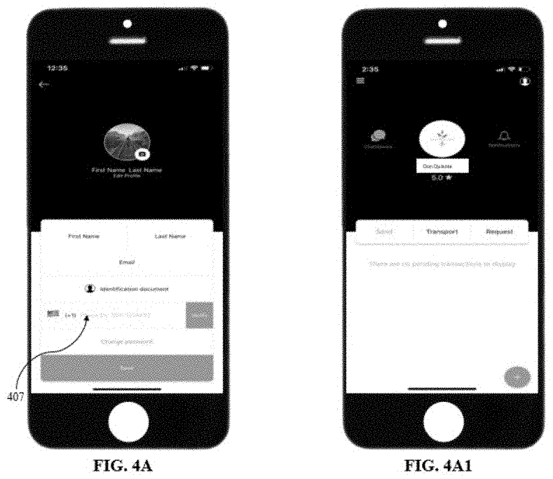

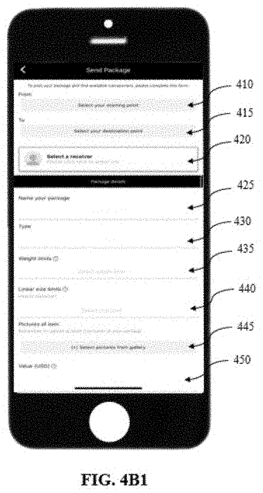

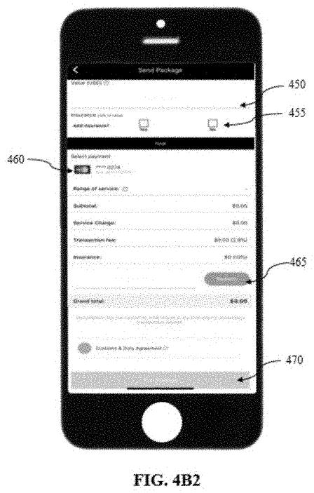

Each of the records of the transporting user, sending user, a receiving user may also include other data sent from each of the remote computing devices of the users, respectively. The database is also configured for receiving the package data of a package that is to be sent. The package data may include a weight limit, a size limits, name of the package, starting point, a destination point, the preferred sending user, a sending user, deadline for package to be delivered to user, date of pickup of package, size requirements of package, delivery location of package, pickup location of package and inspection data. In one embodiment, the aforementioned package data may be associated with one or more barcodes, such as a QR code, configured to interact with a sensor associated with any of the remote computing devices in order to retrieve the package data. In one embodiment, package data may be received by the sensor, such as a camera on the remote computing device, capturing a first plurality of images of the package depicting the weight, size, dimensions, condition, barcode (single or multiple dimension). The first plurality of images may be matched or compared to a second plurality of images taken at a subsequent time-period from the first plurality of images in order to simultaneously confirm that the package has been maintained in the same condition that it was received in and also detect any changes associated with the package. As illustrated in the figures attached to the appendix, the system may also be configured for receiving and displaying images of the package so that the receiving user and transporting data may confirm that the package is what it has been indicated to be by the sending user and also to verify that the transporting user is delivering the package in the same condition that it was received before funds are transferred to the transporting user. It is also understood that money or other types of consideration, such as tokens, credits, etc., may be given to any user for either sending, receiving or transporting packages. FIG. 4A is a graphical user interface (GUI) that may be transmitted, over a communications network 106, to at least one of the sending user, transporting user in receiving user. FIG. 4A is one embodiment of a GUI where the user may input user data associated with the user. For example, the sending user 110 or transporting user 130 may use the camera associated with the respective computing device at the pickup location of the package in order to acquire the data associated with the QR code or to capture the first plurality of images relating to size, weight, dimensions, condition, content verification, or any other pertinent data relating to the package. The first plurality of images is stored on database 104 and matched or compared to the second plurality of images relating to the package acquired by the computing device associated with receiving user 120 or transporting user 130 at the destination location.

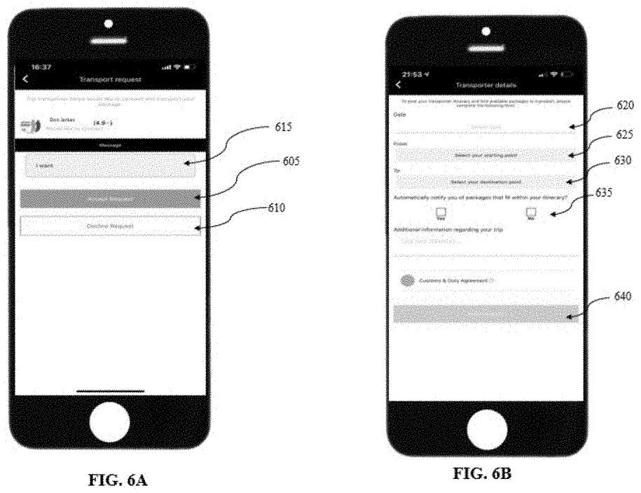

Database 104 may also be configured for accepting receiver information from the receiving user. The receiving information may include data elements for either accepting or rejecting a package by receiving user 120. The receiver acceptance information may include data that the user accepts the package associated with the package data. The receiver acceptance information may also include information that a proposed receiver has denied accepting the package along with reasons for denying the package. The rationale behind the receiver acceptance information is to ensure that the receiving user is not being sent packages that he or she did not request or cannot account for. Receiving user 120, as describe in greater detail when discussing FIG. 6A, is provided a graphical user interface to provide receiver acceptance information. In one embodiment, receiving user 120 is prompted for the receiver acceptance information immediately after sending user 110 submits a request to send a package that indicates receiving user 120 as the receiver.

In one embodiment, database 104 may also include itinerary data received by server 102 from transporting user 130 via a graphical user interface, as illustrated in FIG. 6B. Itinerary data may include travel parameters associated with when the transporting user may transport packages. The travel parameters may include travel dates, travel times, package transport limitations, transporter preferences, and any other information associated with getting a package from an origin to a destination. Database 104 may also be configured for receiving and storing transporting criteria. Transporting criteria or package data may include at least dates for delivery of package, date of pickup of package, size requirements of package, delivery location of package, pickup location of package, and any other applicable constraints associated with transporting a package from an one location to another. In one embodiment, server 102 receives the itinerary data and travel parameters from transporting user 130 via data input fields 620-640, and the transporting criteria from sending user 110, receiving user 120, and/or transporting user 130. Transporting user 130 provides a date of travel within data input field 620, a starting location within data input field 625, and a destination location within in data input field 630. In one embodiment, transporting user 130 may indicate whether or not to receive notification from server 102 relating packages that may be eligible for transportation based on provided itinerary data via a selection of checkboxes of toggle boxes 635. Once transporting user 130 has provided applicable information and agreed to applicable customs and regulations requirements, transporting user 130 may post itinerary data to system 100 by selecting a post itinerary button 640.

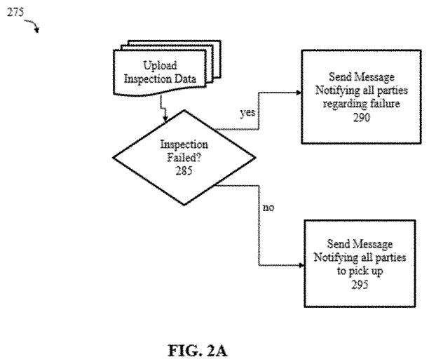

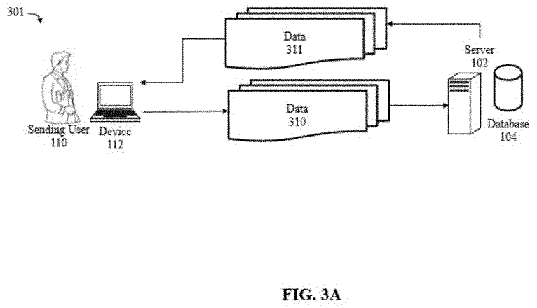

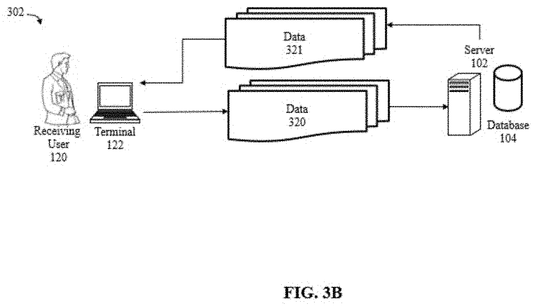

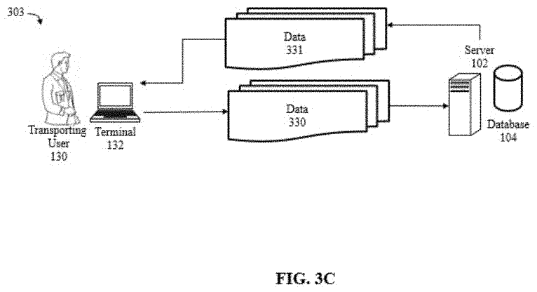

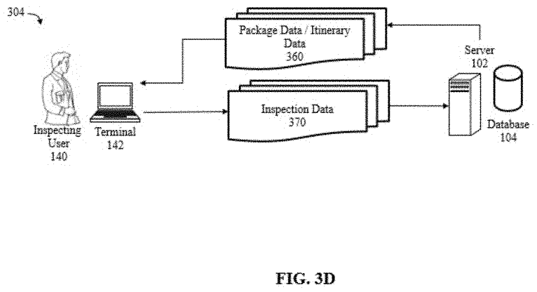

In one embodiment, a plurality of itinerary data is received by server 102 from a plurality of authorized transporting users 130, relevant portions of the itinerary data, such as the travel parameters (including baggage limitations and thereby size restrictions of package—such as, no carry on, no checked bag, carry on, check bag, personal item, no personal item), may be extracted from a document such as an official airline itinerary comprising a departure city, departure time, arrival city, and arrival time and the extracted relevant portions are stored in database 104 in which server 102 utilizes one or more algorithms in order to filter, rank, and determine an optimum transporting user within the plurality of authorized transporting users 130 based on the itinerary data. For example, transporting user 130 may submit itinerary data to terminal 132 (as illustrated in FIG. 3C explained in greater detail throughout) in the form of an American Airlines issued flight itinerary in which server 102 extracts that transporting user 130 is flying from JFK (New York City) departing at 6 am (ET) to LAX (Los Angeles) arriving at 9 am (PT), in which server 102 determines whether the extracted data aligns with the transporting criteria, and automatically selects transporting user 130 or provides sending user 110 the option to select transporting user 130 based on the alignment of the extracted data. Additionally, the itinerary data may also include data related to if the user has paid for a check bag or only has a carry on bag, which in turn allows the system to determine any size limitations of the bag that the user may have and size restrictions of the package the user may be able to transport.

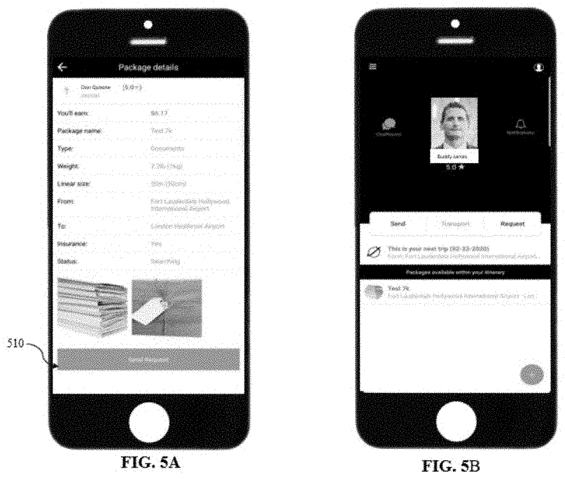

It should be understood that itinerary data may relate to any form of transportation including, but not limited to bus, train, ride-sharing, non-commercial airline, and the like. FIG. 5B is a graphical user interface provided to the remote computing device of transporting user 130 displaying packages that match the itinerary criteria of the transporting criteria, according to an example embodiment. In one embodiment, server 102 may provide a log of available packages ready to be transported based on the transporting criteria and the itinerary data allowing transporting user 130 to pick and choose which packages to transport while simultaneously considering the overall capacity associated with the means to transport packages. This functionality may be provided if transporting user 130 provides a response to toggle boxes 635 of FIG. 6B indicating that he or she wishes to receive notification of packages that align with the itinerary data based on the remaining capacity of their luggage. For example, if the transporting user 130 provides the internal capacity of their luggage to server 102, then the amount of packages to be selected on the log is limited based on the cumulative dimensions of the packages in respect to amount of available space in the luggage provided by transporting user 130.

In one embodiment, server 102 may interact with one or more servers and databases outside of system 100 in order to receive real-time data associated with airlines, flights, train schedules, and any other verified source of transportation scheduling information. For example, the users may be notified of a flight delay, cancellation, or any other type of unplanned/unforeseen incident relating to the flight/voyage associated with transporting user 130 so that the users are notified that the package may arrive outside the projected timeframe for the package to be received. In one embodiment, once a request to send a package is generated by sending user 110, the transporting criteria is received and utilized by server 102 to determine a transporting user 130 that is within the geographic proximity of the pickup location for the package and also is associated with itinerary data that indicates that the arrival city matches and/or is approximate to the destination location. However, it is to be well understood that other applicable factors such as departure/arrival time, transporting user preferences, and any other applicable factors may be accounted for in the one or more algorithms utilized by server 102 in order to determine the optimum transporting user.

Database 104 may also be configured to include a user verification token, which may be stored in each of the user's records. For example, user verification token of transporting user 130 is stored in the user record associated with transporting user 130. A user verification token may be received from a verifying entity after having the user information verified via a verification service, such as but not limited to background check services. The verification token may also be configured to be stored in a ledger or block chain. In one embodiment, the ledger may be a distributed ledger comprising public and private components configured to operate as separate distributed ledgers, and perform authentication functions and management of said functions apparent to those of ordinary skill in the art. The verification token helps facilitate the security of the system along with the users of the system and ensure that the package will be delivered properly by a trustworthy transporter.

Database 104 may also be configured for accepting inspection data 280 from a computing device 142 of an inspecting user 140. An inspecting user may be any business or person that is capable of inspecting a package. In one embodiment, after the transporting user has agreed to transport a package, the sending user is required to deliver to the facility of an inspecting user the package that needs to be delivered. However, in other embodiments the inspection of the package may occur before the receiving user agrees to receive the package or the transporting user agrees to transport the package. The purpose of the inspecting user in certain embodiments so that the package may be inspected to verify that it meets all the criteria as input by the users and also complies with all transportation regulations, laws and guidelines. The inspection data may include a verification token for each of the information related to the package. The database is also configured for storing the message data that will be sent to the users notifying the users that the package complies, or fails to comply with some or all of the required guidelines for the Transporting user to pick up the package in order to transport the package.

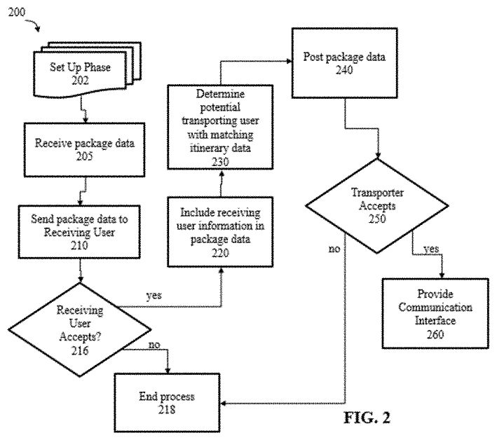

FIG. 2 is a flowchart showing a control flow 200 of one of the processes for receiving and providing information for transporting packages sent between sending user 110 and receiving user 120 via transporting user 130, according to an example embodiment. In step 202, the users set up the software application on each of their respective remote devices. The setup phase may include providing a user GUI for receiving user data, such as the GUI illustrated in FIG. 4A). The user data may include at least a user first name, user last name, user physical address, at least one piece of identification, a user email address, and payment information, which may be credit card information, debit card information, banking information, payment services information, or any other information configured to allow users of system 100 to receive money or credits. FIG. 4A illustrates data input fields 407 where users may input user information. Similar GUIs may be provided to sending user 110, receiving user 120, and transporting user 130 so that all the users may be provide information configured to be stored in database 104. In one embodiment, once the users provide their user information to server 102, the user information is stored on database 104 and accessed by one or more authorizing entities, such as a background check agency or any other entity configured to verify whether or not a user is who they claim to be. In one embodiment, upon successful verification, server 102 generates a profile for each of the users configured to maintain usage history of system 100 by the respective users along with a scoring/rating and review system. The data associated with the profile along with the user system activity history (e.g., packages successfully sent/transported/received) may be stored and managed on the transporting user record, sending user record, and the receiving user record accordingly. For example, the profile may indicate that user “John Smith” has completed four separate deliveries of packages without any issues during any steps of the transportation process in which he would receive a transporter rating of 100%. In one embodiment, the profile may include a sender rating, a receiver rating, and/or a transporter rating configured to be indicative of the user's professionalism and ability to carry out their applicable tasks in order for the package to be transported in a safe and secure manner.

In step 205, sending user 110 provides package data to a graphical user interface, as illustrated in FIGS. 4B1-2, in which sending user 110 may provides the current date or date that the package needs to be delivered to the package destination, along with the starting point or package pick up location in data input field 410, the package destination address in data input field 415, and the name associated with the receiving user 120 who will be receiving the package in data input field 420. In one embodiment, FIG. 4A1 illustrate a GUI that may be provided to the users. One of the improvements of the prior art is that the present embodiment provides to the user a GUI for the user to select a role to perform. The role may be to send a package, receive a package and also for transporting a package. This component allows a particular user to organize and distinguish which packages associated with the particular user are to be sent, received, and transported via a log configured to be updated in real-time. In one embodiment, the scoring/rating and review system may be presented on the GUI for each respective role allowing the particular user to monitor their own score for role of a particular package along with provide feedback regarding the other users who served a different role during the transport of the particular package.

In one embodiment, receiving user 120 must be an authenticated and verified user with a profile on record in order for their name to be populated within data input field 420. In the case where receiving user 120 is a first-time user of system 100, sending user 110 may be prompted to input the phone number or email address of receiving user 120 in which server 102 transmits either a text message or email to the provided input that includes a link to a graphical user interface, such as illustrated in FIG. 4A, providing receiving user 120 the opportunity to register with system 100. In the case where receiving user 120 is an authenticated and verified user on system 100 with a profile, data input field 420 may be automatically populated with information associated with receiving user 120 based on sending user 110 providing the first few characters of the first name, last name, email address, or phone number of receiving user 120 that matches user information on the profile of receiving user 120. Sending user 110 also provides specific package details on the graphical user interface, such as a package name/alias within data input field 425, a type of package (liquid, powder, paper, heavy object, etc.) within data input field 430, the weight or any limits associated with the weight of the package within data input field 435, and the dimensions of the package or any limitations relating to the dimensions/size of the package within data input field 440. In one embodiment, server 102 prompts sending user 110 for images of the package taken with the camera of computing device 111 configured to provide access to the camera roll of the computing device via a selectable camera gallery option 445. Sending user 110 also provides the estimated value of the package and its content within data input field 450. Sending user 110 may continue to scroll along the graphical user interface and answer applicable questions, such as whether to add package insurance to the applicable package by checkboxes or toggles 455. Sending user 110 provides the payment information within data input field 460 and any applicable coupons or vouchers that may be redeemed within data input field 465. Once all applicable information is entered into the graphical user interface, the package request may be submitted by interacting with a post package button 470. In one embodiment, once the applicable information is provided, sending user 110 is provided a package details GUI, as provided in the GUI illustrated in FIG. 5A, where sending user 110 may double check the package details and issue transmission of the request by pressing a send request button 510.

In step 210, once sending user 110 successfully provides the applicable data to data input fields 405-440 and activates the send request button 510, sever 102 generates a request to send a package based on the inputs and transmits the request to receiving user 120 including the package details. In one embodiment, once receiving user 120 receives the request, receiving user 120 is presented an opportunity to review and potentially modify data provided in the request. For example, the receiving user 120 may edit the destination address of the package if the destination address provided by sending user 110 is incorrect or the receiving user 120 may flag or report the sending user 110 if receiving user 120 is not familiar with the package or sending user 110 altogether.

In step 216, server 102 provides receiving user 120 with a GUI, as illustrated in FIG. 6A, that provides receiving user 120 with the opportunity to provide receiver information that indicates that receiving user 120 either accepts the package associated with the package data or rejects the package. In one embodiment, one or more data input fields 615 are provide in the GUI in order to allow receiving user 120 to interact with sending user 110 via a message portal or receiving user 120 may use data input fields 615 to provide a message or notes associated with their decision to accept or reject the package, which is sent to server 102 based on the interaction of receiving user 120 with an accept request button 605 or a reject request button 610 provided on the GUI.

If receiving user 210 provides receiver information that indicates acceptance of the package; then step 220 occurs, if receiving user 210 provides receiver information that indicates rejection of the package; then step 218 occurs and server 102 notifies sending user 110 that the package was rejected along with the reason as to why the package was rejected provided in data input fields 615. Meanwhile, server 102 is configured for providing a user interface for transporting user 130 to add itinerary data. Itinerary data includes at least a starting point and a destination point associated with the voyage of transporting user 130. In one embodiment, itinerary data further comprises preferences of transporting user 130 (e.g. no deliveries after 9 pm), departure time, arrival time, departure and arrival airport, train station, terminal, or any other transportation hub. In one embodiment, itinerary data further comprises travel parameters configured to serve as factors to filter transporting users out of the plurality of transporting users based on the package data. For example, although a particular transporting user 130 may have itinerary data indicating that the traveling itinerary of transporting user 130 aligns with the package data, the size of the luggage associated with the particular transporting user 130 may not have the capacity to fit the dimension of a particular package; thus, due to the particular transporting user 130 providing travel parameters relating to the size of their luggage, the particular transporting user 130 may be filtered out of the plurality of transporting users due to limited capacity of the luggage. In one embodiment, server 102 may utilize one or more algorithms to update the log of available packages ready to be transported in real-time based on continuous monitoring of the capacity of the luggage based on a plurality of luggage data, such as luggage dimensions or already occupied luggage space, provided by transporting user 130. It is to be well understood that other applicable parameters, such as GPS location, social media data, and emergency contact information, as well as many other parameters are within the spirit and scope of the present invention.

In step 220, receiver acceptance information indicates that receiving user 120 accepts the package associated with the package data, and server 102 includes receiving user information in the package data. For example, based on the package data, receiving user 120 has access to review the profile associated with sending user 110 and sending user 110 has access to the profile associated with receiving user 120 in a configuration in which confidential information such as payment information and any other private information is redacted.

In step 230, server 102 determines which transporting user within a plurality of transporting users has itinerary data that aligns with or matches the transporting criteria associated with the package data stored on database 104. In one embodiment, the plurality of transporting users 130 is determined by the itinerary data in addition to the transporting criteria and the geographic proximity of transporting user 130 to the pickup location of the package. In one embodiment, server 102 may perform one or more machine learning operations in order to categorize and rank itinerary data and transporting criteria used for generating an aggregated set of transporting users 130 configured to carry out delivery of the package at issue. In one embodiment, the plurality of transporting users 130 may be listed in order based on the transporting ranking/scoring from previous transporting of packages using system 100.

In step 240, server 102 transmits or posts the package data to a plurality of remote computing devices of transporting users having itinerary data that aligns or matches with transporting criteria within the package data. For example, FIG. 5B is a graphical user interface provided to the remote computing device of the transporting user displaying packages that match the itinerary criteria of the transporting criteria, according to an example embodiment. This feature provides transporting user 130 with the opportunity to select one or more packages that transporting user 130 is able to successfully transport.

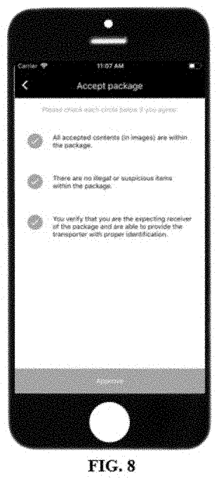

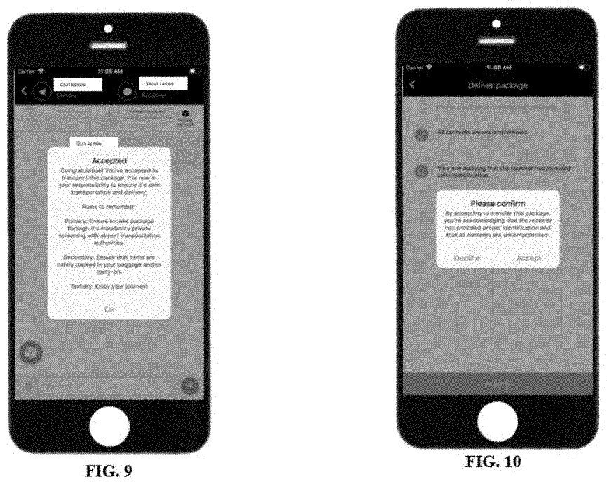

In step 250, transporting user 230 provides a selection of the packages that he/she wishes to transport via providing transporting acceptance data. In one embodiment, transporting user 130 provides the transporting acceptance data indicating agreement to transport the package based on the package data, itinerary data, and transporting criteria, as illustrated in FIG. 10. FIGS. 8-11 refer to various embodiments for transporting user 130 to accept and confirm that they will deliver a package. In order to ensure security of both the package and the users, server 102 issues a series of prompts confirming that transporting user 130 has inspected the package for any hazardous or illegal content, as illustrated in FIG. 8, and acknowledges conformity with any transportation rules, standards, and guidelines (e.g. Transportation Security Administration), as illustrated in FIG. 9. If the transporting acceptance data indicates that transporting user 130 does not accept the package, then step 218 occurs in which the process is terminated.

FIG. 2A is a flowchart showing the process or control flow 275 of one of the processes for providing inspection information for transporting packages sent between a sending user and a receiving user via a transporting user, according to an example embodiment. As mentioned above, in certain embodiments an inspecting user is required to inspect the package before the transporting user may transport the package from a pickup points to a destination. In certain embodiments, a sending user is required to deliver to a facility of the inspecting user 140 or business for the inspecting user to inspected package to determine if the package meets all travel regulations and guidelines. In other embodiments, an inspecting user may meet with the sending user to inspect the package. As show in FIG. 3D, the system may be configured for transmitting to the inspecting user package data, the itinerary data and other data (as illustrated in data packet 360) so that the inspecting user can determine if the package data is appropriate for the itinerary data. The physical inspection may also include inspecting for other requirements as well. After the physical inspection, which may include inspection for unlawful items and illegal items and compliance of the package data and itinerary data (size, package weight, as well as a plurality of different information), in step 280 (illustrated in FIG. 2A), the inspecting user 140 may upload via the remote computing device 140 inspection data related to the inspection of the package. In step 285, the system may determine whether or not the package has passed the inspection based on the comparing the inspection data, itinerary data, transporting data as well as any other data that may be necessary to make a determination if the package meets the requirements for allowing the transporting data to transport the package. If the system determines that the package does not pass inspection or does not meet the criteria required for the package to pass inspection, then, in step 290, data and messages may be transmitted to each other appropriate users. For example, such data and messages may include data for the sending user to go to the facility to adjust the package so that the package will then be in compliance for transmitting. Additionally, such messages may include data informing the users that the package should not be picked up. Additional messages may be sent to the authorities as well as other users if the inspection has been failed. Other type of data or information may be included and is within the spirit and scope of the present invention.

If the system determines that the package passes inspection or meets the criteria required for the package to pass inspection, then, in step 295, data and messages may be transmitted to each other appropriate users. For example, such data and messages may include data for the sending user or transporting user to go to the facility to pick up the package so that the package may be transported. Additionally, other type of data or information may be included and is within the spirit and scope of the present invention. It is also understood that the interfaces provided in FIGS. 8 and 10 may also be provided to the transporting user after picking up the package from the inspecting user. This allows an extra layer of security for the system and also requires that inspecting user conduct a second inspection, which helps increase the safety.

FIG. 3A is a flowchart showing the data flow between the server 102 and the sending user 110. FIG. 3B is a flowchart showing the data flow between the server and the receiving user 120 and FIG. 3C is a flowchart showing the data flow between the server and the transporting user 103. FIG. 3A illustrates that data 310 may be sent from the sending user 110 via the communications network to the server and data 311 will be sent from the server to the sending user so that the GUIs explained above may be displayed on the remote computing device of the sending user. As mentioned above, the data 310, 311 may include data related to information send and related to the receiving user 120 and transporting user. Similarly, FIG. 3B illustrates that data 320 may be sent from the receiving user 120 via the communications network to the server and data 321 will be sent from the server to the receiving user 120 so that the GUIs explained above may be displayed on the remote computing device of the receiving user. As mentioned above, the data 320, 321 may include data related to information send and related to the sending user 120 and transporting user. Similarly, FIG. 3C illustrates that data 330 may be sent from the transporting user 130 via the communications network to the server and data 331 will be sent from the server to the transporting user 130 so that the GUIs explained above may be displayed on the remote computing device of the transporting user. As mentioned above, the data 330, 331 may include data related to information send and related to the receiving user 120 and sending user.

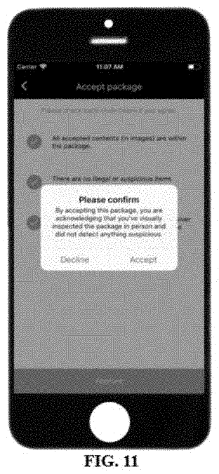

In step 260, server 102 provides a communication interface supporting a virtual chat room including the users for each respective package allowing the users to communicate particular details to ensure secure and efficient delivery of the package. In one embodiment, any changes to one or more of the package data, itinerary data, and transporting criteria must be verified by server 102 before being posted to the virtual chat room in order to provide security to the users. As previously mentioned, in one embodiment, upon arrival of transporting user 130 at the package destination including receiving user 120, receiving user 120 is prompted to provide the second plurality of images of the package along with the agree to terms provided by server 102 that receiving user 120 confirms that the package has been checked for anything suspicious, as illustrated in FIG. 11.

FIG. 12 is a block diagram of a system including an example computing device 600 and other computing devices. Consistent with the embodiments described herein, the aforementioned actions performed by devices 111, 112, 113, 121, 122, 123, 131, 132, 133, 142 and server 102 may be implemented in a computing device, such as the computing device 1200 of FIG. 12. Any suitable combination of hardware, software, or firmware may be used to implement the computing device 1200. The aforementioned system, device, and processors are examples and other systems, devices, and processors may comprise the aforementioned computing device. Furthermore, computing device 1200 may comprise an operating environment for systems 100 and processes 200, providing data related to data flow 301, 302, 303, 304 and GUIS 401, 501, 601 as described above. Processes 200, data related to data flow 301, 302, 303, 304 and GUIS 401, 501, 601 may operate in other environments and are not limited to computing device 1200.

With reference to FIG. 12, a system consistent with an embodiment of the invention may include a plurality of computing devices, such as computing device 1200. In a basic configuration, computing device 1200 may include at least one processing unit 1202 and a system memory 1204. Depending on the configuration and type of computing device, system memory 1204 may comprise, but is not limited to, volatile (e.g. random access memory (RAM)), non-volatile (e.g. read-only memory (ROM)), flash memory, or any combination or memory. System memory 1204 may include operating system 1205, and one or more programming modules 1206. Operating system 1205, for example, may be suitable for controlling computing device 1200's operation. In one embodiment, programming modules 606 may include, for example, a program module 1207 for executing the actions of server 102 and devices 111, 112, 113, 121, 122, 123, 131, 132, 133, 142 for example. Furthermore, embodiments of the invention may be practiced in conjunction with a graphics library, other operating systems, or any other application program and is not limited to any particular application or system. This basic configuration is illustrated in FIG. 12 by those components within a dashed line 1220.

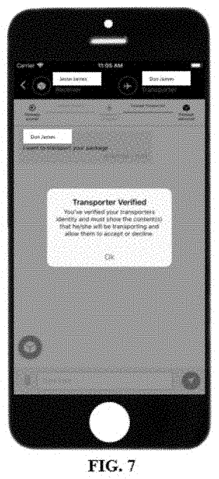

Computing device 1200 may have additional features or functionality. For example, computing device 1200 may also include additional data storage devices (removable and/or non-removable) such as, for example, magnetic disks, optical disks, or tape. Such additional storage is illustrated in FIG. 7 by a removable storage 1209 and a non-removable storage 1210. Computer storage media may include volatile and nonvolatile, removable and non-removable media implemented in any method or technology for storage of information, such as computer readable instructions, data structures, program modules, or other data. System memory 1204, removable storage 1209, and non-removable storage 1210 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1200. Any such computer storage media may be part of device 1200. Computing device 1200 may also have input device(s) 1212 such as a keyboard, a mouse, a pen, a sound input device, a camera, a touch input device, etc. Output device(s) 1214 such as a display, speakers, a printer, etc. may also be included. The aforementioned devices are only examples, and other devices may be added or substituted.

Computing device 1200 may also contain a communication connection 1216 that may allow device 1200 to communicate with other computing devices 1218, such as over a network in a distributed computing environment, for example, an intranet or the Internet. Communication connection 1216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 1204, including operating system 1205. While executing on processing unit 602, programming modules 1206 (e.g. program module 1207) may perform processes including, for example, one or more of the stages of the process 200 as described above. The aforementioned processes are examples, and processing unit 1202 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the invention.

The systems and methods described herein provide improvements to the parcel transporting industry altogether in addition to the data processing and management components of the industry. The systems and methods support organization of received data relating to packages and applies one or more algorithms in order to filter and determine an optimum transporter in addition to providing a platform that enables individuals to schedule on-demand package delivery based on the received packaged data. The system is able to reduce human error commonly associated with the parcel transporting industry and circumvent common issues relating to commercial parcel transporting.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A system, provided over a communications network, for receiving and providing information for transporting packages sent between a sending user and a receiving user via a transporting user, wherein the system comprises:
one or more processors;
one or more storage media storing instructions which, when executed by the one or more processors cause:
sending, to a remote computing device of each a sending user, a receiving user and a transporting user, a graphical user interface for receiving data associated with the sending user, receiving user and transporting user, respectively;
after receiving a request to send a package, providing to the sending user remote computing device, a sending package GUI for accepting package data to be sent to a receiving user, wherein the package data includes package related information;
after receiving the package data, providing to the remote computing device of the receiving user, a receiving package GUI for receiving receiver acceptance information;
wherein if the receiver acceptance information indicates that the receiving user accepts the package associated with the package data, then including the receiving user information in the package data and sending the package data to a plurality of remote computing devices of transporting users having itinerary data that aligns with transporting criteria within the package data; and,
providing to the remote computing device of each of the plurality of transporting users having itinerary data that aligns with transporting criteria within the package data, a transporting package GUI configured for displaying package data having the receiving user information and for receiving transporting acceptance data.

2. The system of claim 1, wherein if transporting acceptance data is received that indicates that the transporting user agrees to transport the package associated with package data, then providing to the sending user remote computing device, receiving user remote computing device and transporting user remote computing device, a communication interface wherein the sending user, receiving user, and transporting user may communicate with each other based on the package data, itinerary data, and transporting criteria.

3. The system of claim 1, wherein the user data includes at least a user first name, user last name, user address, at least one piece of identification, a user email address, and payment information.

4. The system of claim 1, wherein before being allowed to send, receive or transport any package, each user must receive a user verification token to be stored in the corresponding sending user record, receiving user record or transporting user record, wherein the user verification token is received from a verifying entity after having the user information verified via a verification service.

5. The system of claim 4, wherein the user verification token is configured to be stored in a blockchain ledger structure.

6. The system of claim 1, wherein the transporting criteria includes at least dates for delivery of package, date of pick up of package, size requirements of package, delivery location of package, and pickup location of package.

7. The system of claim 1, wherein the system is configured for providing to the remote computing device of the transporting user an itinerary interface for allowing the transporting user to add itinerary data, wherein the itinerary data has a plurality of travel parameters associated with when the transporting user may transport packages.

8. The system of claim 1, wherein the travel parameters further comprises travel dates, travel times, and package transport limitations.

9. The system of claim 1, wherein the package data further comprises a first plurality of images associated with the package configured to be received from the sending user.

10. The system of claim 9, further comprising receiving a second plurality of images associated with the package from the receiving user; wherein the second plurality of images is compared to the first plurality of images in order to verify the package when delivered by the transporting user.

11. The system of claim 1, wherein the plurality of transporting users having itinerary data that aligns with transporting criteria is selected based on the geographic proximity of the plurality of transporting users to a pick up location of the packages.

12. A system, provided over a communications network, for receiving and providing information for transporting packages sent between a sending user and a receiving user via a transporting user, wherein the system comprises:
one or more processors;
one or more storage media storing instructions which, when executed by the one or more processors cause:
sending, to a remote computing device of each a sending user, a receiving user and a transporting user, a graphical user interface for receiving data associated with the sending user, receiving user and transporting user, respectively;
creating a sending record for the sending user, a receiving record for the receiving user and a transporting record for the transporting user, respectively;
storing, in the database, user data received from the sending user, receiving user and transporting user in the record corresponding to the sending user, receiving user and transporting user respectively;
after receiving a request to send a package, providing to the sending user remote computing device, a sending package GUI for accepting package data to be sent to a receiving user, wherein the package data includes package related information and the receiving user data that is proposed to accept the package at a destination location;
after receiving the package data, providing to the remote computing device of the receiving user proposed by the sending user in the sending package GUI, a receiving package GUI for receiving receiver acceptance information, wherein the receiver acceptance information includes data elements for at least one of accepting and rejecting the package identified by the package data input into the package data GUI,
wherein if the receiver acceptance information indicates that the receiving user does not accept the package, then not posting any of the package data to any transporting user, and,
wherein if the receiver acceptance information indicates that the receiving user accepts the package associated with the package data, then including the receiving user information in the package data and sending the package data to a plurality of remote computing devices of transporting users having itinerary data that aligns with transporting criteria within the package data; and
providing to the remote computing device of each of the plurality of transporting users having itinerary data that aligns with transporting criteria within the package data, a transporting package GUI configured for displaying package data having the receiving user information and for receiving transporting acceptance data, wherein the transporting acceptance data includes data elements if the transporting user agrees to transport the package associated with package data.

13. A method for receiving and providing information for transporting packages sent between a sending user and a receiving user via a transporting user comprising:
sending, to a remote computing device of each a sending user, a receiving user and a transporting user, a graphical user interface for receiving data associated with the sending user, receiving user and transporting user, respectively;
creating a sending record for the sending user, a receiving record for the receiving user and a transporting record for the transporting user, respectively;
storing, in the database, user data received from the sending user, receiving user and transporting user in the record corresponding to the sending user, receiving user and transporting user respectively;
after receiving a request to send a package, providing to the sending user remote computing device, a sending package GUI for accepting package data to be sent to a receiving user, wherein the package data includes package related information and the receiving user data that is proposed to accept the package at a destination location;
after receiving the package data, providing to the remote computing device of the receiving user proposed by the sending user in the sending package GUI, a receiving package GUI for receiving receiver acceptance information, wherein the receiver acceptance information includes data elements for at least one of accepting and rejecting the package identified by the package data input into the package data GUI,
wherein if the receiver acceptance information indicates that the receiving user does not accept the package, then not posting any of the package data to any transporting user, and,
wherein if the receiver acceptance information indicates that the receiving user accepts the package associated with the package data, then including the receiving user information in the package data and sending the package data to a plurality of remote computing devices of transporting users having itinerary data that aligns with transporting criteria within the package data;
providing to the remote computing device of each of the plurality of transporting users having itinerary data that aligns with transporting criteria within the package data, a transporting package GUI configured for displaying package data having the receiving user information and for receiving transporting acceptance data, wherein the transporting acceptance data includes data elements if the transporting user agrees to transport the package associated with package data; and
wherein the method is performed by one or more computing devices.

14. The method of claim 13, wherein if transporting acceptance data is received that indicates that the transporting user agrees to transport the package associated with package data, then providing to the sending user remote computing device, receiving user remote computing device and transporting user remote computing device, a communication interface wherein the sending user, receiving user, and transporting user may communicate with each other based on the package data, itinerary data, and transporting criteria.

15. The method of claim 13, wherein before being allowed to send, receive or transport any package, each user must receive a user verification token to be stored in the corresponding sending user record, receiving user record or transporting user record, wherein the user verification token is received from a verifying entity after having the user information verified via a verification service.

16. The method of claim 13, wherein the user verification token is configured to be stored in a blockchain ledger structure.

17. The method of claim 13, wherein the system is configured for providing to the remote computing device of the transporting user an itinerary interface for allowing the transporting user to add itinerary data, wherein the itinerary data has travel parameters associated with when the transporting user may transport packages.

18. The method of claim 11, wherein the package data further comprises a first plurality of images associated with the package configured to be received from the sending user.

19. The method of claim 18, further comprising receiving a second plurality of images associated with the package from the receiving user; wherein the second plurality of images is compared to the first plurality of images in order to verify the package when delivered by the transporting user.

20. The method of claim 11, wherein the plurality of transporting users having itinerary data that aligns with transporting criteria is selected based on the geographic proximity of the plurality of transporting users to a pick up location of the packages.
